(19) United States
(12) Patent Application Publication
(10) Pub. No.: US 2016/0068340 A1
(43) Pub. Date: Mar. 10, 2016

(54) LIFT MECHANISM FOR ROLL-OUT WASTE BIN AND METHOD

(71) Applicant: SCHAEFER SYSTEMS INTERNATIONAL, INC., Charlotte, NC (US)

(72) Inventors: Morris Dwayne Marlow, Statesville, NC (US); Michael Daniel Lewis, Charlotte, NC (US); Clinton Lawrence McDade, Charlotte, NC (US)

(21) Appl. No.: 14/478,659

(22) Filed: Sep. 5, 2014

(51) Int. Cl. B65F 1/14; B65F 1/12; B65F 1/02

(52) U.S. Cl. CPC B65F 1/1452; B65F 1/02; B65F 1/122; B65F 1/1473; B65F 1/1646

(57) ABSTRACT

A roll-out waste bin includes a retention bar that is held in place on the bin by a pair of retention bar housings. A rib in one of the retention bar housings engages one end of the retention bar and a protrusion on the other end of the retention bar and exterior to both of the retention bars housings positions the retention bar.

### TECHNICAL FIELD AND BACKGROUND OF THE INVENTION

This application relates to roll-out waste bins, and more particularly to a feature on the exterior of such a roll-out waste bin that permits the bin to be lifted by an automated lifter mounted on a waste disposal truck for emptying into the waste collection hopper of the truck, and then to be lowered back to the ground. Such bins generally include a large receptacle mounted on wheels with a hinged lid for closing the receptacle except during loading or emptying. The front of the bin includes a retention bar which, in conjunction with a downward lip along the front top rim of the waste bin, is gripped by the automated lifter in order to lift and dump the contents of the waste bin. In typical prior art waste bins a retention bar receiving area is provided on the exterior of the waste bin which holds the retention bar. In its most basic form, this receiving area is formed of two parallel, vertical walls, external to the interior volume of the waste bin, set apart at a distance that is less than the length of the retention bar. See FIG. 1. Each of these vertical walls has an aperture through which the retention bar is placed, with enough clearance to allow the retention bar to spin freely. See FIG. 1A.

Another embodiment of this receiving area has front closeout walls that connect the vertical walls to the waste bin receptacle, thereby creating two retention bar housings, each housing having one vertical wall, one front closeout wall and two external walls of the waste bin receptacle. See FIGS. 2, 2A.

A pair of ribs, one residing inside each of the retention bar housings extend from one of the external walls of the retention bar housings. These ribs trap the retention bar after it has been slid into position through the retention bar housing apertures, preventing the retention bar from moving side-to-side enough to be removed. The ribs are positioned in the retention bar housings to normally interfere with the retention bar and thereby prevent the retention bar from being pulled free of free of the bin. In order to insert the retention bar, these ribs have a suitable degree of flexibility, and are typically bent by the retention bar sufficiently to allow the retention bar to slide past the ribs and enter the retention bar housings, whereupon the ribs spring back into their normal positions, locking the retention bar into the retention bar housings.

This arrangement requires considerable maneuvering to insert the retention bar into both apertures, past the ribs and into the retention bar housings.

This application also discloses a method of installing a retention bar onto a waste bin.

### SUMMARY OF THE INVENTION

It is therefore an object of the present invention to provide a roll-out waste bin that is provided with a retention bar that is simple to install, and that remains securely positioned in its required position.

It is another object of the invention to provide a roll-out waste bin that is provided with a retention bar that can be inserted and retained on the bin, thereby utilizing simplified retention devices.

It is another object of the invention to provide a roll-out waste bin that is provided with a retention bar that can be inserted and retained on the bin utilizing a rib on one side of the retention bar and other retention means on the other side of the retention bar.

It is another object of the invention to provide a method of installing a retention bar onto a waste bin.

These and other objects and advantages of the invention are achieved by providing a roll-out waste bin of the type characterized by having a receptacle mounted on wheels, a hinged lid enclosing an open top of the receptacle, a handle, a downward lip along a front top rim of the receptacle and a vertically spaced retention bar for being grasped by an external lifter for elevating and emptying the contents from the receptacle. The waste bin also includes first and second laterally spaced-part vertical walls extending outwardly and forwardly from a forward side of the receptacle and positioned to form respective first and second retention bar housings.

A first aperture is formed in the first vertical wall and a second aperture is formed in the second vertical wall for receiving the retention bar. The first and second apertures have diameters sufficiently large to permit free rotation of the retention bar in the first and second apertures. A rib is positioned in the first retention bar housing and adapted to abut a first end of the retention bar extending into the first retention bar housing to prevent movement of the retention bar into the first retention bar housing beyond a predetermined point.

A lock cooperates with the exterior of the retention bar between the first and second retention bar housings, and is adapted to engage the second retention bar housing to restrain side-to-side movement of the retention bar out of the first and second apertures.

In accordance with one embodiment of the invention, the rib engages an end face of the retention bar.

In accordance with one embodiment of the invention, the retention bar is cylindrical and the first and second apertures are circular.

In accordance with one embodiment of the invention, the first and second retention bar housings each comprise one vertical wall, one front closeout wall and two external walls of the waste bin receptacle.

In accordance with one embodiment of the invention, the lock comprises a protrusion on an axially-extending surface of the retention bar exterior to both of the first and second vertical walls in order to prevent passage of the retention bar further through the second aperture into the second retention bar housing.

In accordance with one embodiment of the invention, the protrusion comprises a rivet positioned in a hole in the retention bar.

In accordance with one embodiment of the invention, the two external walls of the first and second retention bar housings define a recess having a depth equal to the depth of the vertical walls.

In accordance with one embodiment of the invention, the retention bar is longer than the distance between the first and second vertical walls and shorter than the distance between opposed external walls of the waste bin receptacle.

In accordance with one embodiment of the invention, a method of installing a retention bar onto a roll-out waste bin is provided. The waste bin is of the type characterized by having a receptacle mounted on wheels, a hinged lid enclosing an open top of the receptacle, a handle, a downward lip along a front top rim of the receptacle wherein the retention bar is vertically spaced from the lip for being grasped by an external lifter for elevating and emptying the contents from the receptacle. The method includes the steps of providing first and second laterally spaced-part vertical walls extending outwardly and forwardly from a forward side of the receptacle, and positioned to form respective first and second retention bar housings. A first aperture is formed in the first vertical wall and a second aperture is formed in the second vertical wall, each aperture adapted for receiving one end portion of the retention bar. The first and second apertures have diameters sufficiently large to permit free rotation of the retention bar in the first and second apertures. A rib is positioned in the first retention bar housing and is adapted to abut a first end of the retention bar extending into the first retention bar housing to prevent movement of the retention bar into the first retention bar housing beyond a predetermined point. A lock cooperates with the exterior of the retention bar between the first and second retention bar housings, and is adapted to engage the second retention bar housing to restrain side-to-side movement of the retention bar out of the first and second apertures. A retention bar is provided that is longer than the distance between the first and second vertical walls and shorter than the distance between opposed external walls of the waste bin receptacle. The retention bar is inserted into and through the second aperture into the second retention bar housing to a point where the retention bar can be moved into alignment with the first and second apertures. The retention bar is moved out of the second retention bar housing a sufficient distance to cause the retention bar to enter the first aperture and pass into the first retention bar housing and abut the rib with an opposing end portion of the retention bar remaining in the second retention bar housing. A protrusion is applied to the surface of the retention bar at a position where the retention bar is locked against being removed from either the first or second retention bar housing.

According to another embodiment of the invention, the step of applying a protrusion to the surface of the retention bar comprises the step of applying a rivet through a wall of the retention bar.

### BRIEF DESCRIPTION OF THE DRAWING FIGURES

The present invention is best understood when the following detailed description of the invention is read with reference to the accompanying drawings, in which:

FIG. 1 is a roll-out waste bin according to one prior art design with which the retention bar of the present invention may be utilized;

FIG. 1A is a fragmentary enlarged view of the retention bar area of the waste bin shown in FIG. 1;

FIG. 2 is a waste bin of a type with which the retention bar of the present invention may be utilized;

FIG. 2A is a fragmentary enlarged view of the retention bar mechanism shown in FIG. 2;

FIG. 3 is a top plan view of the waste bin having a retention bar mechanism according to the prior art design of FIGS. 2 and 2A;

FIG. 3A is a fragmentary enlarged view of the retention bar mechanism shown in FIG. 3;

FIG. 4 is a top plan view of a waste bin having a retention bar mechanism according to one preferred embodiment of the present invention;

FIG. 4A is a fragmentary enlarged view of the novel retention bar mechanism shown in FIG. 4;

FIGS. 5-9 are enlarged fragmentary sequential views of a retention bar according to a preferred embodiment of the present invention being inserted into the retention bar housings of a waste bin;

FIG. 10 is a further enlarged fragmentary view of the position of the retention bar shown in FIG. 9; and

FIG. 11 is a still further fragmentary view showing a side elevation of the top plan view shown in FIG. 10.

### DETAILED DESCRIPTION OF THE PREFERRED EMBODIMENT

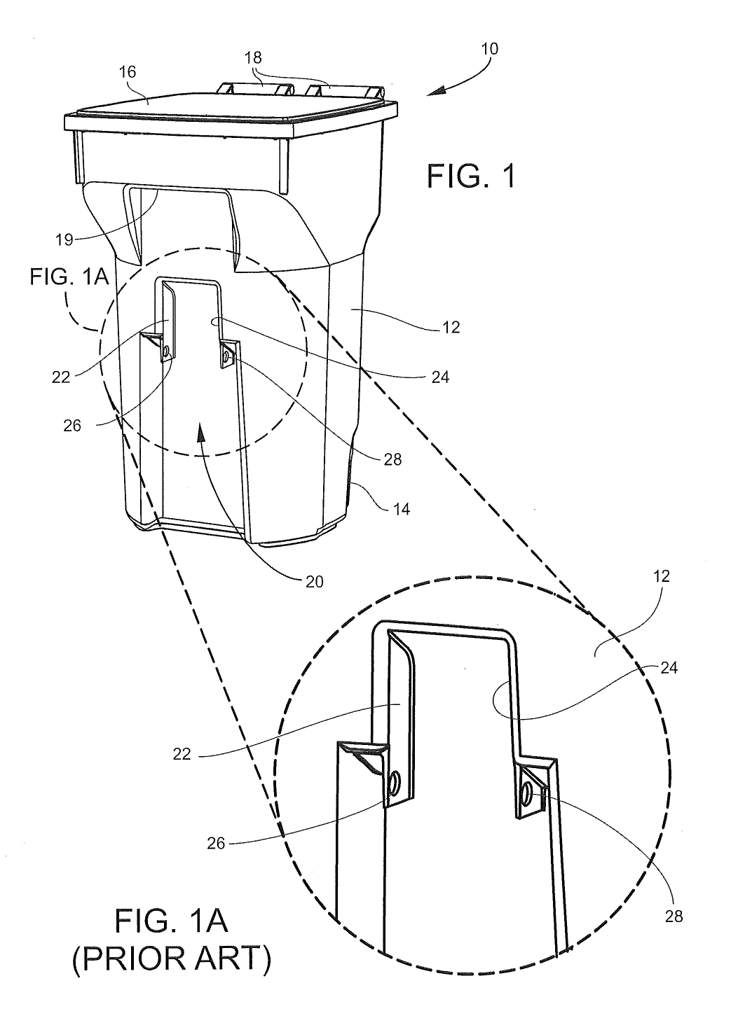

Referring now to the drawings, a roll-out waste bin 10 that includes a prior art retention bar receiving area according to one prior art design is shown in FIGS. 1 and 1A, and includes a waste receptacle 12 mounted on wheels 14, one shown, and covered by a hinged lid 16, with handles 18.

A downwardly-facing lip 19 extends along the front top rim of the waste receptacle 12 and is gripped by the automated lifter in order to lift and dump the contents of the waste bin 10. A retention bar receiving area 20 is formed of two parallel, vertical walls 22, 24 that are external to the interior volume receptacle 12 and spaced apart at a distance that is less than the length of the retention bar, not shown. The vertical walls 22, 24 have respective apertures 26, 28 through which the retention bar is placed, with enough clearance to allow the retention bar to spin freely.

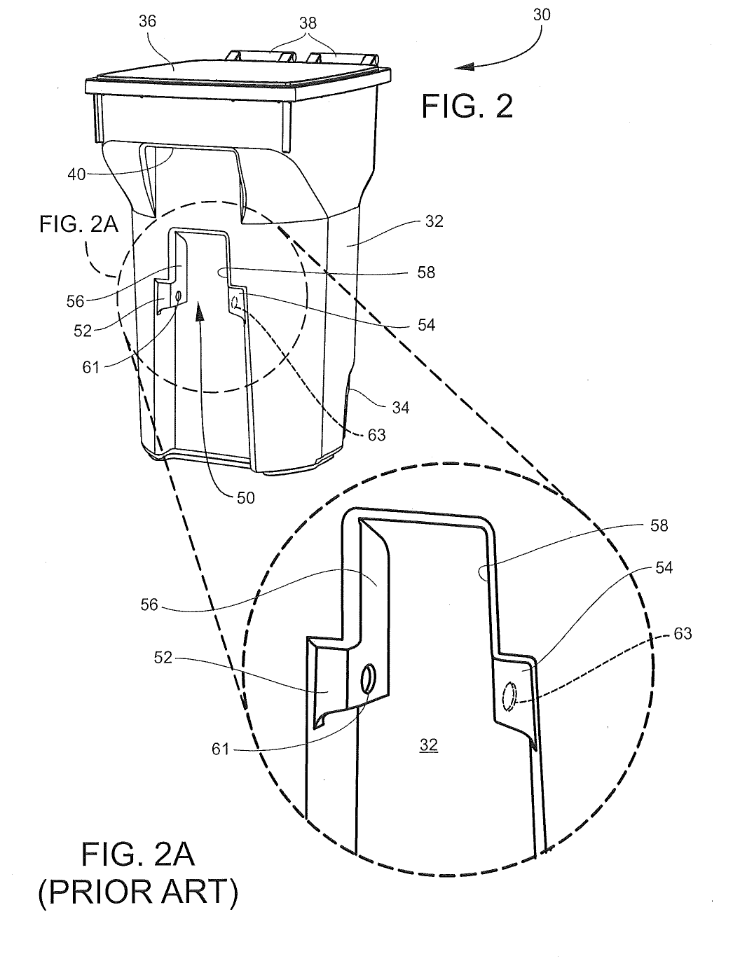

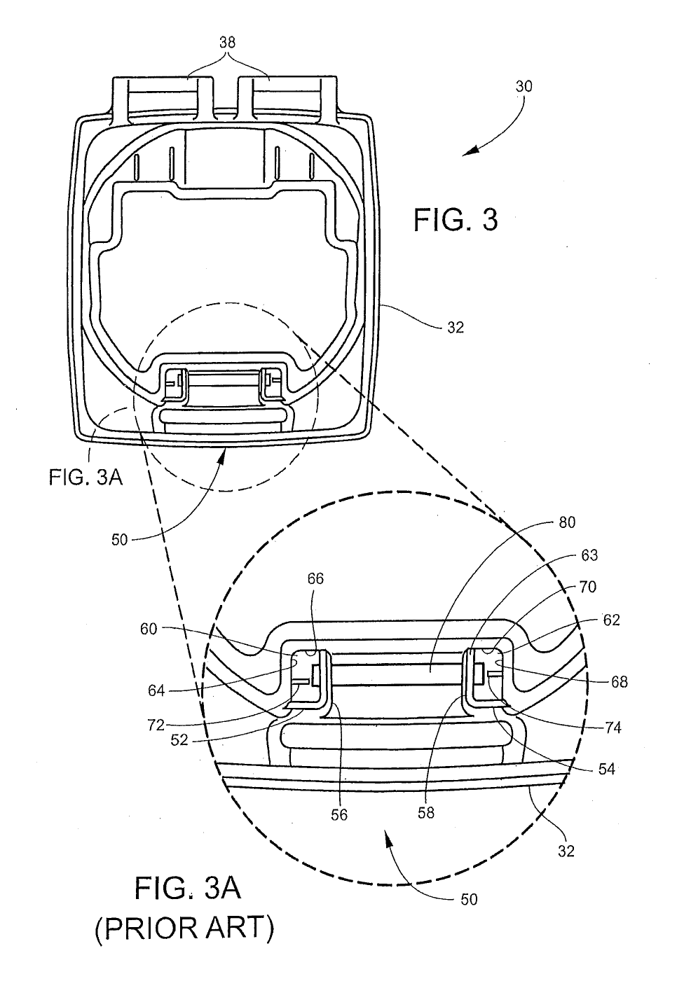

Another waste bin that includes a prior art retention bar receiving area according to another design is shown at reference numeral 30 in FIGS. 2, 2A, 3 and 3A. The waste bin 30 includes a waste receptacle 32 mounted on wheels 34, one shown, and covered by a hinged lid 36, with handles 38 and a downwardly-facing lip 40, as described above. A retention bar receiving area 50 includes front closeout walls 52, 54 that connect vertical walls 56, 58 to the waste bin receptacle 32, thereby creating two retention bar housings 60, 62, see FIG. 3A, each housing 60, 62 having one vertical wall 56, 58, respectively, one front closeout wall 52, 54 respectively, and two external walls 64, 66 and 68, 70, respectively, of the waste bin receptacle 32. Vertical walls 56, 58 include respective opposed retention bar apertures 61, 63.

As best shown in FIG. 3A, a pair of ribs 72, 74, one residing inside each of the retention bar housings 60, 62, respectively, are formed integral to the receptacle 32 and extend from the respective external walls 64, 68 of the retention bar housings 60, 62. These ribs 72, 74 trap the retention bar 80 after it has been slid into position through the retention bar housing apertures, preventing the retention bar from moving side-to-side enough to be removed. The ribs 72, 74 are positioned in the retention bar housings 60, 62 to normally interfere with the retention bar 80 and thereby prevent the retention bar 80 from being pulled free of free of the bin 30. In order to insert the retention bar 80, these ribs 72, 74 have a degree of flexibility, and are typically deflected by the retention bar 80 during insertion sufficiently to allow the retention bar 80 to slide past the ribs 72, 74 and enter the retention bar housings 60, 62, whereupon the ribs 72, 74 move back into their normal positions that interfere with removal of the retention bar 80, locking the retention bar 80 into the retention bar housings 60, 62.

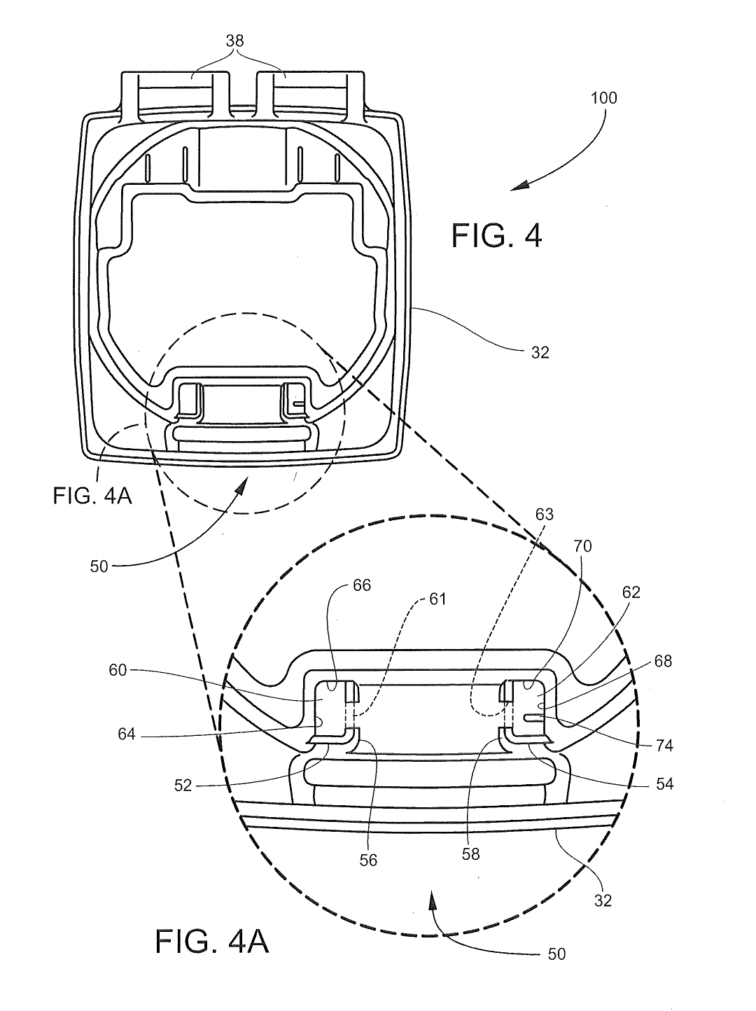

Referring now to FIGS. 4-9, top plan views of a roll-out bin 100 is shown. The bin 100 includes features and elements that are the same as the features and elements of bin 30 and as to those features and elements, the same reference numerals are used. As is illustrated in FIGS. 4-9, the principal difference in the bin 30 and bin 100 is that the rib 72 of the retention bar housing 60 has been omitted in accordance with the novel features described and claimed in this application.

Applicant also notes that the invention of this application is not dependent on the presence of all of the features of the bin 30. The invention is equally usable with reference to bin 10 illustrated in FIGS. 1, 1A, and any other roll-out waste bin having opposed walls into which a retention bar is inserted and retained.

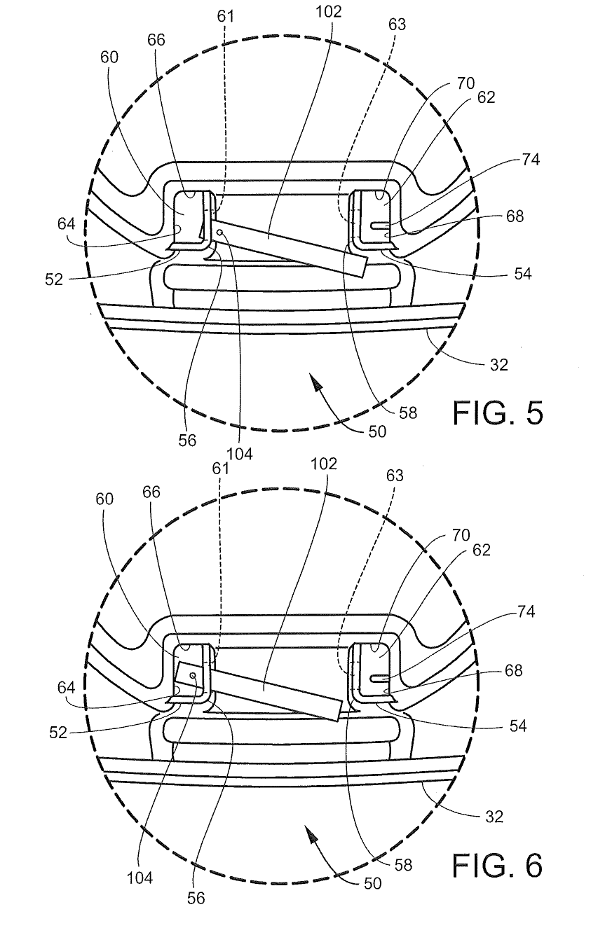

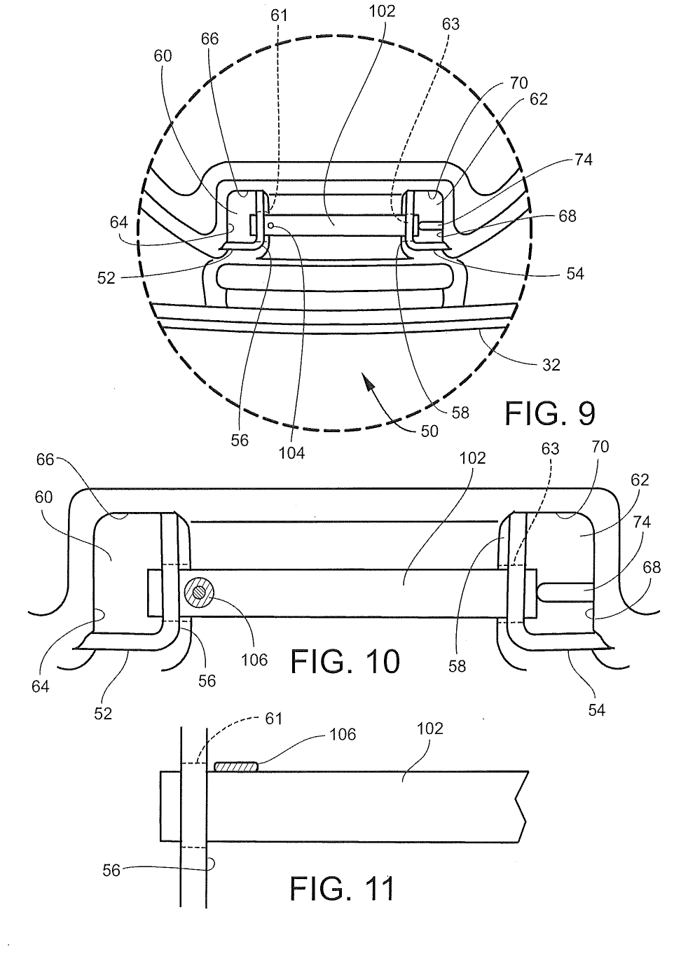

With these explanations in mind, FIGS. 4-9 illustrate sequentially the insertion of a retention bar 102 in accordance with the method of the invention of this application. As shown in FIG. 5, one end of the retention bar 102 is inserted into the aperture 61 in retention bar housing 60 at an angle necessitated to achieve clearance of the opposing retention bar housing 62 and the vertical wall 58. In accordance with the particular embodiment shown in FIGS. 4-9, a hole 104 is formed in the retention bar 102 proximate one end. The end of the retention bar 102 with this hole 104 is inserted first. The hole 104 is positioned on the retention bar 102 in a location whereby it resides outside the vertical wall 56 of the retention housing 62 when insertion of the retention bar 102 is complete. See FIGS. 9-11.

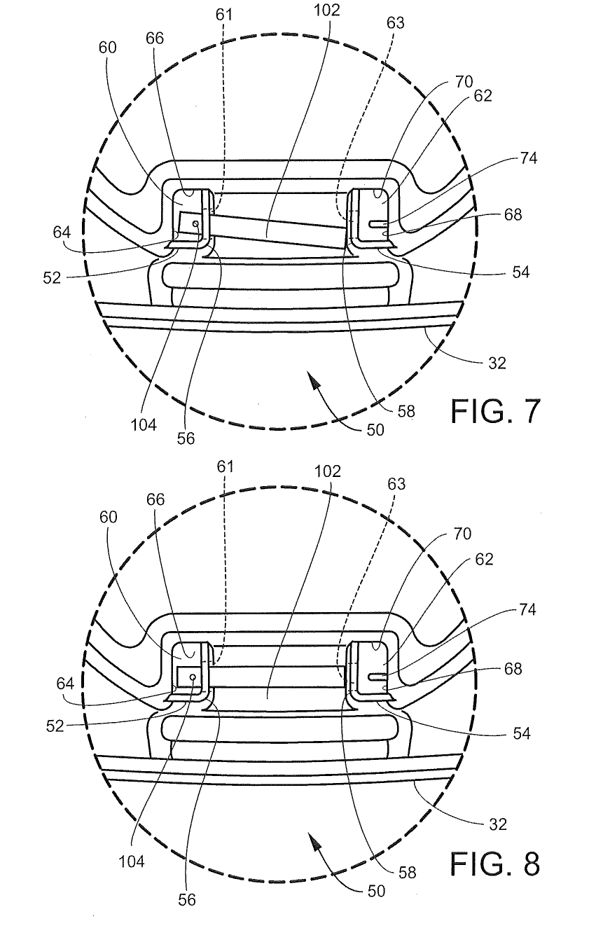

As shown in FIGS. 6-8, when the retention bar 102 is fully extended into the retention bar housing 60, its length is sufficiently short to enable it to clear the vertical wall 58, as shown in FIG. 7. In the position shown in FIG. 8, the retention bar 102 is slid through the aperture 63 in the vertical wall 58 and into the retention bar housing 62 until it is stopped from further insertion by the rib 74. In this position, shown in FIG. 9, the hole 104 resides outside the retention bar housing 60. As shown in FIGS. 10 and 11, a drive rivet 106 is then inserted into the hole 104. The head of the rivet 106 extends sufficiently above the axially-extending surface of the retention bar 102 to interfere with and prevent the retention bar 102 from sliding further back into the retention bar housing 60. This feature in combination with the engagement of the other end of the retention bar 102 with the rib 74 locks the retention bar 102 into the area between the two retention housings 60, 62, while still permitting it to rotate as needed.

Alternative devices may be employed to replace the rivet 106, and may include an end cap, not shown, on the retention bar 102 having an axially-extending protrusion of such proportion that the protrusion can deform under pressure to allow the placement of the retention bar 102 through the aperture 61 and return to its original shape when said pressure is relieved, with its original shape creating interference with the exterior wall 56 of the retention bar housing 60 that opposes the rib 74.

Another alternative embodiment may be an end cap of the retention bar 102 having multiple protrusions, not shown, of such proportions that the protrusions deform under pressure to allow the placement of the retention bar 102 through the aperture 61, returning to their original shape when the pressure is relieved, with their original shape creating interference with the exterior wall 56 of the retention bar housing 60 that opposes the rib 74.

Other possible embodiments, not shown, can include but are not limited to snap-fit type mechanisms, either integral to the retention bar 102 or as part of a secondary component added to the retention bar 102, such as spring-released buttons or hooks.

A lift mechanism for a roll-out waste bin according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

I claim:

1. In a roll-out waste bin of the type characterized by having a receptacle mounted on wheels, a hinged lid enclosing an open top of the receptacle, a handle, a downward lip along a front top rim of the receptacle and a vertically spaced retention bar for being grasped by an external lifter for elevating and emptying the contents from the receptacle, the combination therewith including:
(a) first and second laterally spaced-part vertical walls extending outwardly and forwardly from a forward side of the receptacle, and positioned to form respective first and second retention bar housings;
(b) a first aperture formed in the first vertical wall and a second aperture formed in the second vertical wall for receiving the retention bar, the first and second apertures having diameters sufficiently large to permit rotation of the retention bar in the first and second apertures;
(c) a rib positioned in the first retention bar housing and adapted to abut a first end of the retention bar extending into the first retention bar housing to prevent movement of the retention bar into the first retention bar housing beyond a predetermined point; and
(d) a lock cooperating with the exterior of the retention bar between the first and second retention bar housings, and adapted to engage the second retention bar housing to restrain side-to-side movement of the retention bar out of the first and second apertures.

2. In a roll-out waste bin according to claim 1, wherein the rib comprises an integrally-formed elongate member that is adapted to engage an end face of the retention bar.

3. In a roll-out waste bin according to claim 1, wherein the retention bar is cylindrical and the first and second apertures are circular.

4. In a roll-out waste bin according to claim 1, wherein the first and second retention bar housings each comprise one vertical wall, one front closeout wall and two external walls of the waste bin receptacle.

5. In a roll-out waste bin according to claim 4, wherein the lock comprises a protrusion on an axially-extending surface of the retention bar exterior to both of the first and second vertical walls to prevent passage of the retention bar further through the second aperture into the second retention bar housing.

6. In a roll-out waste bin according to claim 5, wherein the protrusion comprises a rivet head positioned in a hole in the retention bar.

7. In a roll-out waste bin according to claim 4, wherein the two external walls of the first and second retention bar housings define a recess having a depth equal to the depth of the vertical walls.

8. In a roll-out waste bin according to claim 4, wherein the retention bar is longer than the distance between the first and second vertical walls and shorter than the distance between opposed external walls of the waste bin receptacle.

9. A method of installing a retention bar onto a roll-out waste bin of the type characterized by having a receptacle mounted on wheels, a hinged lid enclosing an open top of the receptacle, a handle, a downward lip along a front top rim of the receptacle wherein the retention bar is spaced vertically from the lip for being grasped by an external lifter for elevating and emptying the contents from the receptacle, comprising the steps of:
(a) providing first and second laterally spaced-part vertical walls extending outwardly and forwardly from a forward side of the receptacle, and positioned to form respective first and second retention bar housings;
(b) providing a first aperture formed in the first vertical wall and a second aperture formed in the second vertical wall for receiving the retention bar, the first and second apertures having diameters sufficiently large to permit rotation of the retention bar in the first and second apertures;
(c) providing a rib positioned in the first retention bar housing and adapted to abut a first end of the retention bar extending into the first retention bar housing to prevent movement of the retention bar into the first retention bar housing beyond a predetermined point;
(d) providing a lock cooperating with the exterior of the retention bar between the first and second retention bar housings, and adapted to engage the second retention bar housing to restrain side-to-side movement of the retention bar out of the first and second apertures;
(e) providing a retention bar that is longer than the distance between the first and second vertical walls and shorter than the distance between opposed external walls of the waste bin receptacle;
(f) inserting the retention bar into and through the second aperture into the second retention bar housing to a point where the retention bar can be moved into alignment with the first and second apertures;
(g) moving the retention bar out of the second retention bar housing a sufficient distance to cause the retention bar to enter the first aperture and pass into the first retention bar housing and abut the rib with an opposing end portion of the retention bar remaining in the second retention bar housing;
(h) applying a protrusion to the surface of the retention bar at a position where the retention bar is prevented from being removed from either the first or second retention bar housing.

10. A method according to claim 9, wherein the step of applying a protrusion to the surface of the retention bar comprises the step of applying a rivet through a wall of the retention bar.
